(19) United States
(12) Patent Application Publication
(10) Pub. No.: US 2007/0226691 A1
(43) Pub. Date: Sep. 27, 2007

(54) Associating attribute tags with test cases

(75) Inventors: Scott M. Happell, Redmond, WA (US); Ujjwal Sarin, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/360,083

(22) Filed: Feb. 23, 2006

(51) Int. Cl. G06F 9/44

(52) U.S. Cl. 717/124

(57) ABSTRACT

A computing system for associating one or more attribute tags with one or more executable test cases. A test case is accessed by the computing system. In addition, various attribute tags are also accessed by the computing system. The attribute tags comprise one or more attributes that describe properties of the test case. The attribute tags are then associated with the test case. Thus, the attribute tags permit useful designation of a variety of attributes as being associated with the test case.

### CROSS-REFERENCE TO RELATED APPLICATIONS

Not applicable

### BACKGROUND

Computing systems have revolutionized the way we work and play. Computing systems come in a wide variety of forms including laptop computers, desktop computers, personal digital assistants, telephones, and even devices that have not been conventionally associated with computing systems such as, for example, refrigerators and automobiles. Computing systems may even comprise a number of constituent computing systems interconnected via a network. Thus, some computing systems may be small enough to fit in the palm of the hand, while others are spread over much of the globe.

Regardless of their physical form, computing systems are composed of hardware and software. The hardware includes most fundamentally at least one processor and memory. The software include instructions that may be embodied in the memory or in storage, and that can be accessed and executed by the processor(s) to direct the overall functionality of the computing system. Thus, software is critical in enabling and directing the functionality of the computing system.

The software, however, is often susceptible to a host of errors when first developed. In addition, software is often updated or otherwise changed, which may also create errors. These errors often will cause the software to fail at its intended function or operation. Even with the most valiant of efforts, software can become so complex, that it would be practically impossible to have error-free code.

In order to detect such errors and to ascertain that software is properly functioning, frequent testing of the software is generally performed. Such testing is often accomplished through the use of multiple test cases. Each test case is typically an executable program that is configured to test a different functional aspect of software. Thus, by executing the individual test cases, errors in the software can be potentially discovered and corrected.

However, as software has become more complex, the number of test cases necessary to properly test software has multiplied. It is now not uncommon for several thousand test cases to be executed when testing a particular complex piece of software. The execution of such a large number of test cases can be time consuming and often requires a large amount of system resources. Compounding the problem, the large number of test cases produces an equally large number of test results that must be evaluated.

In order to make execution of test cases more efficient, some test cases specify a priority of the test case to indicate its importance. This priority may be used to specify a subset of test cases to execute and also may be used to specify a subset of test results for evaluation. However, simply specifying a priority is still quite inflexible. For example, large numbers of test cases may still have to be executed or evaluated. In addition, simply specifying a priority of a test case does not give a test case user the ability to specify a specific subset of test cases for execution or evaluation using other desirable criteria.

### BRIEF SUMMARY

Embodiments disclosed herein relate to the association of one or more attribute tags with one or more executable test cases. A test case is accessed by a computing system. In addition, various attribute tags are also accessed by the computing system. The attribute tags comprise one or more attributes that describe properties of the test case. The attribute tags are then associated with the test case. Thus, the attribute tags permit useful designation of a variety of attributes as being associated with the test case.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 schematically illustrates a suitable computing environment that may implement features of the present invention;

FIG. 2A schematically illustrates a processing flow in which various components operate to associate a plurality of attribute tags with a test case in accordance with one aspect of the principles of the present invention;

FIG. 2B schematically illustrates a processing flow in which various components operate to associate a plurality of attribute tags with test results of the test case of FIG. 2A in accordance with one aspect of the principles of the present invention;

FIG. 2C schematically illustrates a processing flow in which various components operate to report a particular test result of the test results of FIG. 2B in accordance with one aspect of the principles of the present invention;

FIG. 3 illustrates a flowchart of a method for associating a plurality of attribute tags with a test case in accordance with one aspect of the principles of the present invention;

FIG. 4 illustrates a flowchart of a method for associating a plurality of attribute tags with test results produced by executing the test case of FIG. 3 in accordance with one aspect of the principles of the present invention;

FIG. 5 illustrates a flowchart of a method for determining that a test case of FIG. 3 should be executed in accordance with one aspect of the principles of the present invention; and

FIG. 6 illustrates a flowchart of a method for changing one or more attribute tags of the test case of FIG. 3 without changing the source code of the test case in accordance with one aspect of the principles of the present invention.

### DETAILED DESCRIPTION

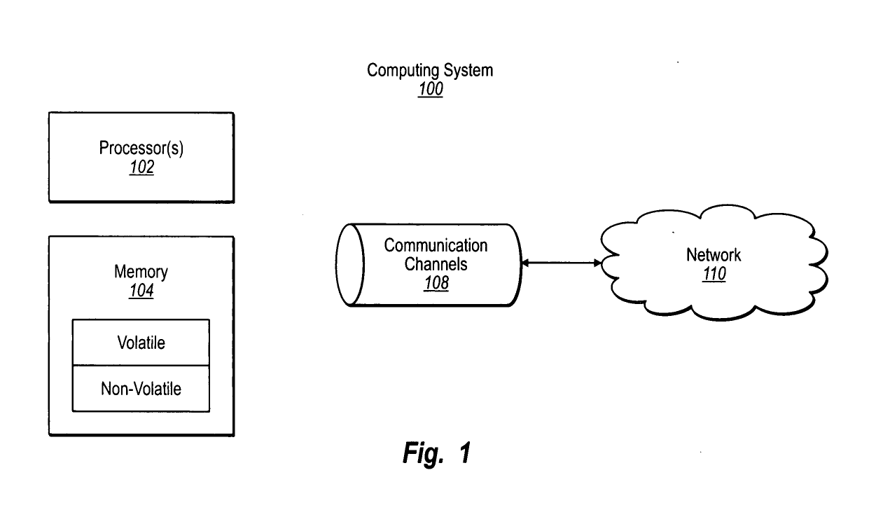

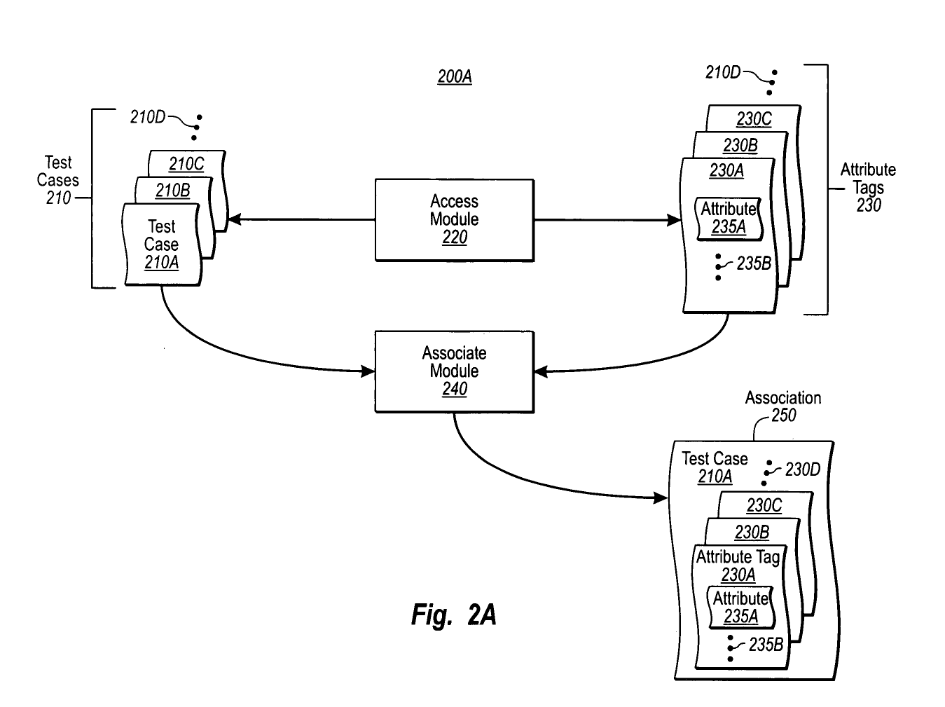

Embodiments of the present invention extend to the systems, methods, and computer program products for associating one or more attribute tags with one or more executable test cases. A test case is accessed by a component of the computing system. In addition, various attribute tags are also accessed by a component of the computing system. The attribute tags comprise one or more attributes that describe properties of the test case. The attribute tags are then associated with the test case. First, an example computing system in which features of the present invention may operate will be described with respect to FIG. 1. Then, embodiments of the present invention will be described in further detail with respect to FIGS. 2A through 6.

The embodiments of the present invention may comprise a special purpose or general-purpose computer including various computer hardware, as discussed in greater detail below. FIG. 1 shows a schematic diagram of an example computing system 100 that may be used to implement features of the present invention. The described computing system is only one example of such a suitable computing system and is not intended to suggest any limitation as to the scope of use or functionality of the invention. Neither should the invention be interpreted as having any dependency or requirement relating to any one or combination of components illustrated in FIG. 1.

Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

Referring to FIG. 1, in its most basic configuration, a computing system 100 typically includes at least one processing unit 102 and memory 104. The memory 104 may be system memory, which may be volatile, non-volatile, or some combination of the two. An example of volatile memory includes Random Access Memory (RAM). Examples of non-volatile memory include Read Only Memory (ROM), flash memory, or the like. The term “memory” may also be used herein to refer to non-volatile mass storage such as physical storage media. Such storage may be removable or non-removable, and may include (but is not limited to) PCMCIA cards, magnetic and optical disks, magnetic tape, and the like.

As used herein, the term “module” or “component” can refer to software objects or routines that execute on the computing system. The different components, modules, engines, and services described herein may be implemented as objects or processes that execute on the computing system (e.g., as separate threads). While the system and methods described herein may be implemented in software, implementations in hardware and in combinations of software and hardware are also possible and contemplated.

In the description that follows, embodiments of the invention are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Turning now to FIG. 2, FIG. 2A illustrates a process flow 200A in which various components operate to associate attribute tags with a test case in accordance with one embodiment disclosed herein. Note that the process flow 200A is one of many different process flows that may be used by embodiments disclosed herein and should not be used to limit the scope of the appended claims.

Process flow 200A includes one or more executable test cases 210. For example, test cases 210 is shown in FIG. 2A as including a test case 210A, 210B, 210C and any number of additional test cases as illustrated by ellipses 210D. Test cases 210 may include any reasonable test case configured to test the operation and/or functionality of any software application. Note that the actual test performed by the test cases 210 and the actual software that the test cases operate on is unimportant to the embodiments disclosed herein. Typically, test cases 210 may comprise executable code that when executed by the processors 102 produces test results.

Process flow 200A also includes one or more attribute tags 230. In FIG. 2A, attribute tags 230 are illustrated as attribute tags 230A, 230B, 230C and any number of additional attribute tags as depicted by ellipses 230D. The attribute tags 230 may be used to tag one or more of the test cases 210. The attribute tags may then be used to help access a particular test result and/or to determine a particular test case to execute as will be described in more detail to follow.

The attribute tags 230 may comprise one or more attributes that describe properties of a test case. In FIG. 2A, attribute tag 230A is shown as comprising attribute 235A and any additional number of attributes 235B. Note that although it is not illustrated, attribute tags 230B, 230C and 230D may also comprise one or more attributes. Furthermore, the exact number of attributes that comprise an attribute test is not important to the embodiments disclosed herein.

As mentioned above, the attributes describe properties of a test case. For example, in some embodiments the attributes may include one of a test case owner, a component to be tested, a test case behavior, and/or test input values. Note that this list of attributes is not exhaustive and is only listed to show specific examples of the numerous attributes that may be included in the attribute tags 230. As will be appreciated after having reviewed this description, any arbitrary or generic data that describes a property of a test case may be implemented as an attribute.

Process flow 200A further includes an access module 220 and an associate module 240, both of which may be implemented as software, hardware, or any combination of software and hardware. Access module 220 is configured to access both the test cases 210 and the attribute tags 230. In some embodiments, the test cases 210 and the attribute tags 230 may be accessed by different access modules.

The accessed test cases 210 and attribute tags 230 may then be provided to associate module 240. In this case, associate module 220 may make an association 250 which represents the association of a test case 210A and a plurality of attribute tags 230. As illustrated, the attribute tags 230 may comprise one or more attributes 235A-235B. Accordingly, the components of process flow 200A operate to facilitate the association of a test case with a plurality of attribute tags comprising one or more attributes.

The following is a specific example of attribute tags specifying a component and a specific test case owner that have been associated with a test case in accordance with an embodiment described herein. In the example, the component is the component “engine” and the test case owner is “John Doe”. Further, the example illustrates a pubic class that calls a test case. Finally, the example shows that specific test logic follows the attribute tags in the code. The specific test logic is the actual code of the test case that has had the attribute tags associated with it.

[Component (“engine’)]
[Owner (“John Doe”)]
Public class TestGetCommand
{
.../Test logic goes here
}

FIG. 2B illustrates a process flow 200B in which various components operate to associate a plurality of attribute tags with test results of the test case of FIG. 2A in accordance with an exemplary embodiment. Again note that the process flow 200B is one of many different process flows that may be used by embodiments disclosed herein and should not be used to limit the scope of the appended claims.

As illustrated, process flow 200B includes an execute/associate module 260 which may be implemented in software, hardware, or any combination of the two. In some embodiments, execute/associate module 260 may be implemented as separate modules. Execute/associate module 260 is configured to execute the association 250 that represents an association of test case 210A and a plurality of attribute tags 230 as described previously. The execution of association 250 produces test results 280, which may consist of test results 280A, 280B, 280C, and any number of additional test results as illustrated by ellipses 280D. Test results 280 may be the results of the test performed by test case 210A. Accordingly, the make-up of test results 280 will depend on the nature of test case 210A.

In addition to producing test results 280, execute/associate module 260 is also configured to associate the plurality of attribute tags associated with the test case that produced the test results with those test results. For example, as depicted in FIG. 2B, test case 210A is associated with attribute tags 230A-230D and their corresponding attributes. Accordingly, execute/associate module 260 associates the resulting test results 280 with the attribute tags 230A-230D of test case 210A. Although the attribute tags are only illustrated as associated with test result 280A, the attribute tags may also be associated with test results 280B-280D.

In some embodiments, the attribute tags 230 associated with test case 210A may be used for determining whether test case 210A should be executed. For example, association 250 may be provided to a filter 270, which may be implemented in hardware, software, or any combination of the two. The filter 270 may also be provided with a search attribute 275, which is used to identify a subset of test cases 210 to execute and which may correspond to an attribute tag 230 of a test case 210. The filter may then determine whether any of the attribute tags 230 match search attribute 275. For example, the filter may compare the search attribute 275 with the attribute tags 230 of test case 210A. If the filter determines there is a match, then test case 210A may be provided to execute/associate module 260 for execution. If, on the other hand, a match is not determined, then test case 210A is not executed.

For example, suppose that search attribute 275 specified a particular test case owner. Further suppose that test case 210A included an attribute tag 230A comprising an attribute 235A that also specified a particular test case owner. In this case, filter 270 would determine that that test case 210A matched search attribute 275, thus allowing test case 210A to be executed. Accordingly, use of the associated attribute tags allows for a particular test case 210 or a subset of test cases 210 to be designated for execution without having to execute the entire set of test cases 210. Advantageously, this saves on system resources and test runtime. Note, however, that the use of filter 270 to determine that a test case or subset of test cases should be executed is only one example of numerous possible ways to make the required determination and therefore should not be used to limit the scope of the embodiments discloses herein.

Referring now to FIG. 2C, a process flow 200C in which various components operate to report a particular test result in accordance with one exemplary embodiment disclosed herein is illustrated. Note that the process flow 200C is one of many different process flows that may be used by embodiments disclosed herein and should not be used to limit the scope of the appended claims.

Process flow 200C includes a filter 290, which may be implemented in hardware, software, or any combination of the two. In some embodiments, filter 290 may be the same as filter 270 described in relation to FIG. 2B, although this is not required. Filter 290 is provided test results 280 that have been associated with the plurality of attribute tags 230 as previously described. The filter 290 may also be provided with a search attribute 215, which is used to identify a subset of test results 280 to report and which may correspond to an attribute tag 230 of the test results 280. In a similar manner as described above in relation to filter 270, the filter 290 determines whether any of the attribute tags 230 match search attribute 215. Any matching test results may be reported as matching test result(s) 216, which represent the subset of test results 280 that were associated with an attribute tag that matches search attribute 215. The reported matching test results 216 may then be analyzed for compliance and/or test failure or other test parameters.

For example, if a user provides a search attribute 215 that specifies a specific component of the test case to be tested, then any test result 280 that was associated with an attribute tag 230 comprising an attribute that also specified the component to be tested would be reported. Advantageously, this process allows for the selection of a single test result or subset of test results to be reported without the need to report the entire set of test results, thus saving time and system resources. Note, however, that the use of filter 290 to determine that a test case or subset of test cases should be reported is only one example of numerous possible ways to make the required determination and therefore should not be used to limit the scope of the embodiments discloses herein.

In some embodiments, filter 290 may be a push-based filter configured to determine desired test results on-the-fly as the test results are produced. In such an embodiment, a RSS reader may be implemented in conjunction with the filter 290 to display the subsets of the test results that march the desired search attribute. This advantageously allows for extra flexibility in viewing desired test results as they are produced.

In still other embodiments, a first set of test results 206 produced from a test case 210A may be associated with attribute tags 230 according to the embodiments previously described. The first set of test results may then be stored in a persistent memory 205. At a later time, test results 280 produced from the test case 210A, which in this embodiment may represent a second set of test results, may be associated with attribute tags 230 as has been previously been described. Filter 290 may then be provided the first set of test results 206 and test results 280.

Filter 290 may then ascertain the current state of the test case 210A based on an analysis of the test results 206 and 280. For example, the attribute tags 230 may specify an owner of test case 210A. While analyzing test results 206, filter 290 may ascertain that the test results of the test case belonging to the specified owner indicate a test failure. As test results 206 were taken at a time prior to test results 280, filter 290 may then analyze test results 280 to ascertain if test results of the test case belonging to the specified owner still indicate a failure. If a test failure is still indicated, then the filter, which may include an attribute tag change module 295 implemented as software, hardware, or any combination thereof, may make a change to one or more of the attribute tags of test case 210A and other test cases owned by the specified owner.

These changes may indicate that test case 210A and other test cases owned by the specified owner should be run more frequently until the test results produced from the test cases no longer indicate a test failure. There may be other changes that may be made to the attribute tags of a test case as warranted. Accordingly, the attribute tags of a test case may be changed without the changing the underlying source code of the test case. In this way, a test case may be marked for more frequent testing without the need to recompile the test case source code.

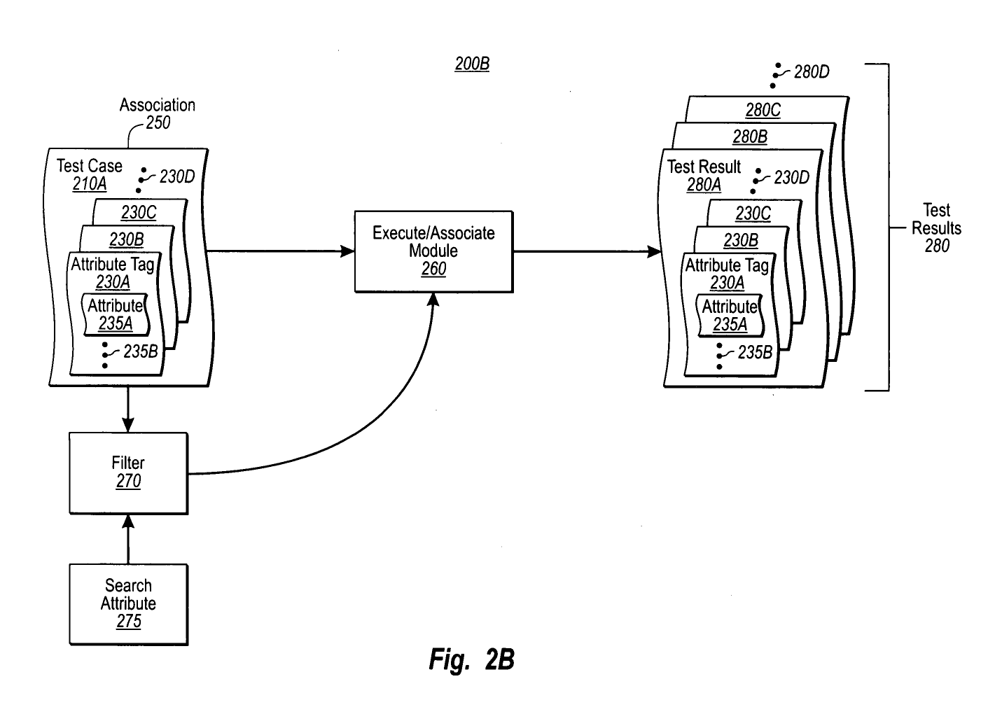

Referring now to FIG. 3, a flow chart of a method 300 for associating a test case with a plurality of attribute tags is depicted. Note that although method 300 will be described with frequent reference to the process flows of FIGS. 2A-2C, this is by way of example only. It will be appreciated that method 300 may also be practiced in other process flows and environments.

Method 300 includes an act of accessing a test case (act 302). For example, an access module 220 may access a test case 210A. As mentioned above, test case 210A may be configured to test a software application and to produce test results when executed by computing system 100. When implemented in software, the access module 220 may be part of a computer program product. The computer program product may have one or more computer-readable media having thereon computer-executable instructions that, when executed by one or more processors of a computing system, cause the access module to access the test case 210A.

Method 300 further includes a functional, result-oriented step for tagging the test case with one or more attribute tags (step 304). This may include any corresponding acts of accomplishing this result. However, in the illustrated embodiment, the step 304 includes corresponding acts 310 and 311.

Method 300 also includes an act of accessing a plurality of attribute tags (act 310). For example, access module 220 may access the plurality of attribute tags 230. As mentioned previously, the attribute tags 230 comprise one or more attributes, for instance attributes 235, which describe properties of the test case. These attributes may include one of a test case owner, a component to be tested, a test case behavior, and test input values. As in act 302, the access module 220 may be implemented as part of a computer program product that when executed by a computing system causes the access module to access the attribute tags 230. Note that in the embodiments disclosed herein act 302 may occur before act 310, after act 310, or the two acts may occur in parallel. According, the sequence of acts 302 and 310 is unimportant to the embodiments disclosed herein.

In addition, method 300 includes an act of associating the plurality of access tags with the test case (act 311). For example, associate module 240 may associate test case 210A with attribute tags 230 as represented by association 250. In this way, a test case is associated with a plurality of attribute tags. When implemented in software, the associate module 240 may be part of a computer program product. The computer program product may have one or more computer-readable media having thereon computer-executable instructions that, when executed by one or more processors of a computing system, cause the associate module to associate test case 210A and attribute tags 230.

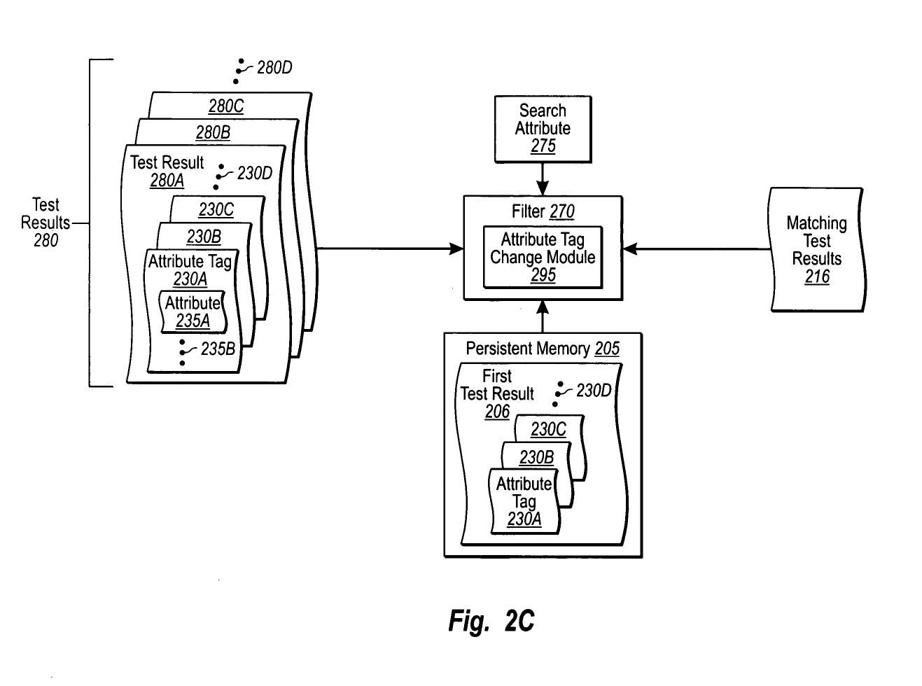

Referring now to FIG. 4, a method 400 for associating a plurality of attribute tags with test results produced by executing a test case that has previously been associated with an attribute tag is depicted. As the method 400 may be performed using the general processing flow 200 of FIGS. 2A-2C, frequent reference will be made to these figures. As noted above, however, it will be appreciated that method 400 may also be practiced in other process flows and environments.

Method 400 includes an act of executing a test case to produce test results (act 402). For example, execute/associate module 260 may execute test case 210A of association 250. As a result of the execution, test results 280 are produced. As mentioned previously, test results 280 may comprise any number of test results.

Method 400 further includes an act of associating the plurality of attribute tags with the test results (act 404). For example, execute/associate module 260 may associate the attribute tags 230 with the test results 280. As mentioned previously, the attribute tags 230 comprise one or more attributes which describe properties of the test case that produced the test results.

Method 400 also includes the acts of providing a search attribute to a filter (act 406) and providing the test results to the filter (act 408). For example, search attribute 215 may be provided to filter 290. As discussed above, search attribute 215 is used to identify a subset of test results 280 to report and may correspond to an attribute tag 230 of the test results 280. In addition, test results 280, which were associated with attribute tags 230 in act 404, may be provided to filter 290. Note that as illustrated, act 408 may occur any time before act 406 or it may occur in parallel with and/or after act 406.

Method 400 further includes an act of the filter determining that the test results match the search attribute (act 410). For example, filter 290 may compare the search attribute 215 with the attribute tags associated with the test results 280. Based on this comparison, filter 290 may determine which subset of test results 280 match search attribute 215. For instance, if search attribute 215 specified a test case owner, than filter 290 would determine that any test case 280 that was associated with an attribute tag specifying the test case owner was a match.

Method 400 finally includes an act of reporting the test results as matching the search attribute (act 412). For example, filter 290 may report matching test result(s) 216 that match the search attribute 215. In some embodiments, filter 290 may implement an RSS reader for reporting the matching test result(s) 216. As mentioned previously, test result(s) 216 are the subset of test results 280 that were associated with an attribute tag 230 that matched search attribute 215. As mentioned previously, this advantageously allows for only the reporting of a desired subset of test results.

There may be instances where there are no test results 280 that are associated with an attribute tag that matches the search attribute. In such cases, filter 290 may not report any matching test result(s) 216.

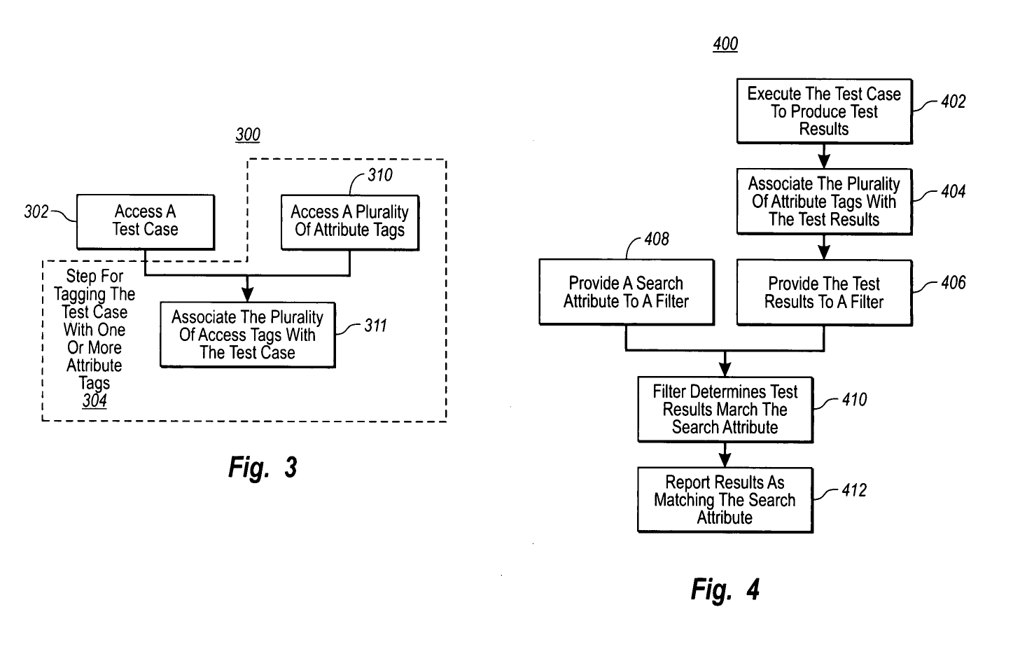

FIG. 5 depicts a method 500 for determining that a test case associated with a plurality of attribute tags should be executed. As with the methods previously described, method 500 will be described with reference to FIGS. 2A-2C, although this is by way of example only and should not be used to limit the scope of the appended claims.

Method 500 includes a functional, result-oriented step for determining that a test case should be executed based on the plurality of attribute tags it is associated with (step 501). This may include any corresponding acts of accomplishing this result. However, in the illustrated embodiment, the step 501 includes corresponding acts 510-514.

For example, method 500 includes an act of providing a search attribute to a filter (act 510) and an act of providing the test case to the filter (act 512). For example, search attribute 275, which is described in detail above, may be provided to filter 270. Likewise, association 210 that includes test case 210A and attribute tags 230 may also be provided to filter 270. Note that in the embodiments disclosed herein act 510 may occur before act 512, after act 512, or the two acts may occur in parallel. According, the sequence of acts 510 and 512 is unimportant to the embodiments disclosed herein.

Method 500 further includes an act of the filter determining that the test case matches the search attribute (act 514). For example, filter 270 may determine that test case 210A is associated with an attribute tag that matches search attribute 275 in a manner already discussed. If a match is found, then test case 210A may be executed. As mentioned above, this allows for specific subsets of test cases to be executed without the need to execute the entire set of test cases.

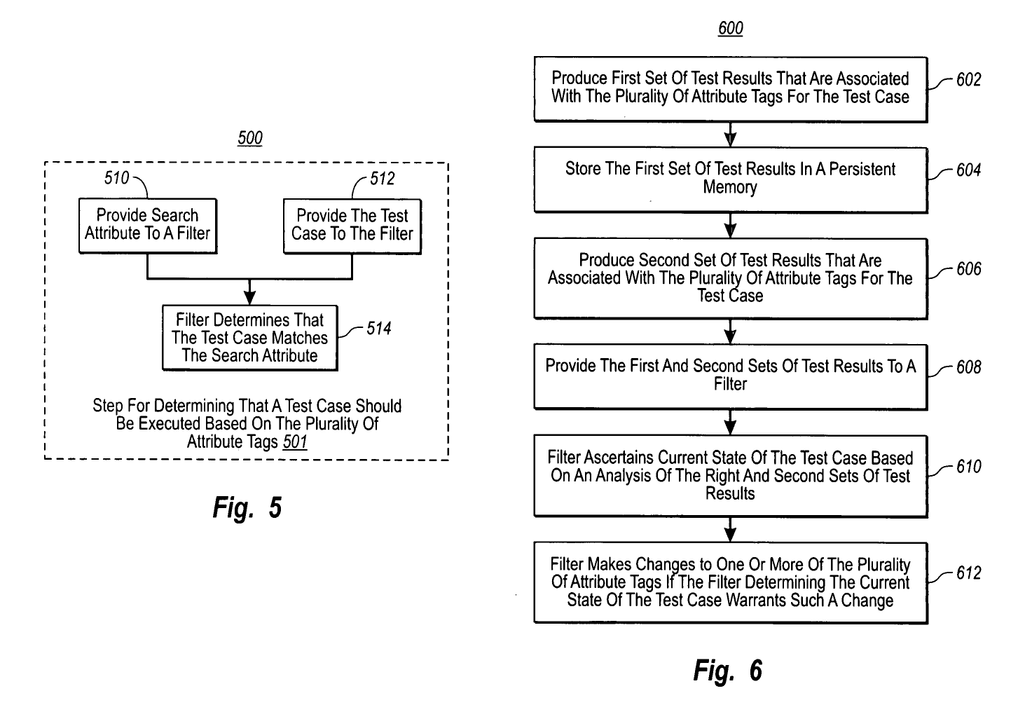

Referring now to FIG. 6, a method 600 for changing one or more attribute tags of a test case without changing the source code of the test case is depicted. Method 600 will be described with frequent reference to the process flows of FIGS. 2A-2C. As with the other methods, this should not be used to limit the scope of the appended claims.

Method 600 includes the acts of producing a first set of test results that are associated with the plurality of attribute tags for the test case (act 602), storing the first set of test results in the persistent memory (act 604), producing a second set of test results that are associated with the plurality of attribute tags for the test case (act 606), and providing the first and second sets of test results to a filter (act 608). For example, a first set of test results 206 produced by executing test case 210A may be associated with attribute tags 230 in the manner previously described and may be stored in persistent memory 205. At a latter time, test results 280 that are also produced by executing test case 210A may also be associated with attribute tags 230. In this case, test results 280 may represent a second set of test results. Test results 206 and 280 may then be provided to filter 290.

Method 600 also includes an act of the filter ascertaining the current state of the test case based on an analysis of the first and second sets of test results (act 610). For example, filter 290 may ascertain the current state of the test case 210A based on an analysis of the test results 206 and 280. For instance, the attribute tags 230 may specify an owner of test case 210A. While analyzing test results 206, filter 290 may ascertain that the test results of the test case belonging to the specified owner indicate a test failure. As test results 206 were taken at a time prior to test results 280, filter 290 may then analyze test results 280 to ascertain if test results of the test case belonging to the specified owner still indicate a failure.

Method 600 further includes an act of the filter making changes to one or more of the plurality of attribute tags of the test case without changing the source code of the test case if the filter determines that the current state of the test case warrants such a change (act 612). For example, filter 290 may make changes to one or more of the plurality of attribute tags 230 if the current state of the test case warrants such a change. For instance, if a test failure is still indicated in the example of act 610, then the filter 290, which may include an attribute tag change module 295, may make a change to one or more of the attribute tags of test case 210A and other test cases owned by the specified owner. These changes may indicate that test case 210A and other test cases owned by the specified owner should be run more frequently until the test results produced from the test cases no longer indicate a test failure. Advantageously, the attribute tags of test case 201A may be changed without changing the underlying source code of the test case. In this way, a test case may be marked for more frequent testing without the need to recompile the test case source code.

Accordingly, the principles of the present invention present a way to associate a test case with attribute tags comprising any desirable criteria. The use of the associated attribute tags allows for a particular test case or a subset of test cases to be designated for execution without having to execute the entire set of test cases. Similarly, the use of the attribute tags allows for particular test results to be reported without having to report the entire set of test results. Advantageously, this saves on system resources and test runtime. In addition, the ability to use any desirable criteria as an attribute tag offers more flexibility to a test case user than only being able to designate a test case by a priority.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a computing system that has access to one or more executable test cases that are configured to produce test results when executed by the computing system, a method for associating one or more attribute tags with the one or more test cases in a manner that permits useful designation of a variety of attributes as being associated with the test cases, the method comprising:
an act of accessing a test case;
an act of accessing a plurality of attribute tags that comprise one or more attributes that describe properties of the test case; and
an act of associating the plurality of attribute tags with the test case.

2. A method in accordance with claim 1, wherein the attributes include one of a test case owner, a component to be tested, a test case behavior, and test input values.

3. A method in accordance with claim 1, further comprising:
an act of executing the test case to produce test results; and
an act of associating the plurality of attribute tags with the test results such that the plurality of attribute tags describe properties of the test case that produced the test results.

4. A method in accordance with claim 3, wherein the computing system further includes a filter, the method further comprising:
an act of providing a search attribute to the filter;
an act of providing the test results to the filter;
an act of the filter determining that the test results match the search attribute; and
an act of reporting the test results as matching the search attribute.

5. A method in accordance with claim 4, wherein the filter is a push-based filter that is configured to filter the test results as they are produced to determine if the test results match the search attribute.

6. A method in accordance with claim 1 further comprising:
a step for determining that the test case should be executed based on the plurality of attribute tags.

7. A method in accordance with claim 6, wherein the computing system further includes a filter, the act of determining comprising:
an act of providing a search attribute to the filter;
an act of providing the test case to the filter; and
an act of the filter determining that the test case matches the search attribute.

8. A method in accordance claim 1, wherein the computing system further includes a persistent memory and a filter, the method further comprising:
an act of producing a first set of test results that are associated with the plurality of attribute tags for the test case;
an act of storing the first set of test results in the persistent memory;
an act of producing a second set of test results that are associated with the plurality of attribute tags for the test case;
an act of providing the first and second sets of test results to the filter;
an act of the filter ascertaining the current state of the test case based on an analysis of the first and second sets of test results; and
an act of the filter making changes to one or more of the plurality of attribute tags of the test case without changing the source code of the test case if the filter determines that the current state of the test case warrants such a change.

9. A computer program product for use in a computing system including one or more executable test cases that are configured to produce test results when executed by the computing system, the computer program product comprising one or more computer-readable media having thereon computer-executable instructions that, when executed by one or more processors of a computing system, cause the computing system to perform a method for associating one or more attribute tags with the one or more of the test cases in a manner that permits useful designation of a variety of attributes as being associated with the test cases, the computer-executable instructions comprising:
an access module for accessing a test case;
an access module for accessing a plurality of attribute tags that comprise one or more attributes that describe properties of the test case; and
an associate module for associating the plurality of attribute tags with the test case.

10. A computer program product in accordance with claim 9, wherein the attributes includes one of test case owner, component to be tested, test case behavior, and test input values

11. A computer program product in accordance with claim 9, further comprising computer-executable instructions comprising:
an execute module for executing the test case to produce test results; and
an associate module for associating the plurality of attribute tags with the test results such that the plurality attribute tags describe properties of the test case that produced the test results.

12. A computer program product in accordance with claim 11, wherein the computing system further includes a filter, the computer-executable instructions that when executed by one or more processors of a computing system, further causes the computing system to perform the following:
an act of providing a search attribute to the filter;
an act of providing the test results to the filter;
an act of the filter determining that the test results match the search attribute; and
an act of reporting the test results as matching the search attribute.

13. A computer program product in accordance with claim 9 further comprising computer-executable instructions that when executed by one or more processors of a computing system, further causes the computing system to perform the following:
a step for determining that the test case should be executed based on the plurality of attribute tags.

14. A computer program product in accordance with claim 13, wherein the computing system further includes a filter, the computer-executable instructions for determining that the test case should be executed based on the plurality of attribute tags comprising computer-executable instructions that, when executed by one or more processors of a computing system, further causes the computing system to perform the following:
an act of providing a search attribute to the filter;
an act of providing the test case to the filter; and
an act of the filter determining that the test case matches the search attribute.

15. A computer program product in accordance claim 1, wherein the computing system further includes a persistent memory and a filter, the computer-executable instructions further comprising computer-executable instructions that, when executed by one or more processors of a computing system, further causes the computing system to perform the following:
an act of producing a first set of test results that are associated with the plurality of attribute tags for the test case;
an act of storing the first set of test results in the persistent memory;
an act of producing a second set of test results that are associated with the plurality of attribute tags for the test case;
an act of providing the first and second sets of test results to the filter;
an act of the filter ascertaining the current state of the test case based on an analysis of the first and second sets of test results; and
an act of the filter making changes to one or more of the plurality of attribute tags of the test case without changing the source code of the test case if the filter determines that the current state of the test case warrants such a change.

16. A computer program product in accordance with claim 9, wherein the one or more computer-readable media are each physical storage and/or memory media.

17. In a computing system including one or more test cases that are configured to produce test results when executed by the computing system, a method for associating one or more attribute tags with the one or more of the test cases, the method comprising:
an act of accessing a test case; and
a step for tagging the test case with one or more attribute tags.

18. A method in accordance with claim 17, wherein the step for uniquely tagging the test case comprises:
an act of accessing a plurality of attribute tags that comprise one or more attributes that describe properties of the test case; and
an act of associating the plurality of attribute tags with the test case.

19. A method in accordance with claim 18, further comprising:
an act of executing the test case to produce test results; and
an act of associating the plurality of attribute tags with the test results such that the plurality attribute tags describe properties of the test case that produced the test results.

20. A method in accordance with claim 18 further comprising:
a step for determining that the test case should be executed based on the plurality of attribute tags.
